(19) United States
(12) Patent Application Publication
(10) Pub. No.: US 2017/0036712 A1
(43) Pub. Date: Feb. 9, 2017

(54) TELESCOPING BOOM FOR TOWING WITH A 5TH WHEEL

(71) Applicant: Daniel Deardorff, Rancho Cucomonga, CA (US)

(72) Inventor: Daniel Deardorff, Rancho Cucomonga, CA (US)

(21) Appl. No.: 14/818,025

(22) Filed: Aug. 4, 2015

(51) Int. Cl. B62D 53/08

(52) U.S. Cl. CPC B62D 53/0857

(57) ABSTRACT

Improvements in a telescoping boom for towing with a 5^{th} wheel for the telescoping boom to allow a single person to connect and transport two vehicles. The individual can drive the 5^{th} wheel to the truck, connect the truck with the 5^{th} wheel towing vehicle and drive both vehicles to another location over streets and highways. The telescoping boom mounts within the bed of the truck. The boom is adjustable with hydraulics that can change the angle of the boom relative to the bed of the truck. The boom provides the able to lift rear wheels of the truck that will be towed. The ability to lift the rear wheels allows the truck to be easily towed while the front wheels can freely turn to allow the truck to corner around turns.

### CROSS REFERENCE TO RELATED APPLICATIONS

This application is a continuation-in-part of applicant's co-pending application Ser. No. 62/033,779 filed Aug. 6, 2014 the entire contents of which is hereby expressly incorporated by reference herein.

### STATEMENT REGARDING FEDERALLY SPONSORED RESEARCH OR DEVELOPMENT

Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

Field of the Invention

This invention relates to improvements in towing a truck. More particularly, the present telescoping boom for towing with a 5^{th} wheel is a boom that is mounted within the bed of a truck. The boom is extendable to fit a hitch in a 5^{th} wheel towing vehicle. This allows the truck with the boom to be quickly connected to a 5^{th} wheel tow vehicle, the rear wheels of the vehicle with the boom are lifted and towed.

Description of Related Art Including Information Disclosed Under 37 CFR 1.97 and 1.98

Many times a truck or other vehicle is driven from a starting location to a destination station. Many times multiple trucks are taken to the destination station. To return the truck to the starting location requires transporting two drivers from the starting location to the destination. Once the two drivers reach the destination, each driver must transport the two separate vehicles. This doubles the amount of manpower to transport the vehicle with the boom. When the vehicle to be towed has and integrated boom only a single driver of a 5^{th} wheel vehicle is required to drive to the destination, attach the boom the 5^{th} wheel tow pad and drive away with just a single driver.

There are patents for towing a vehicle, and most of these patents and invention require the vehicle that is being towed to have a mechanism that lifts the tires or the entire vehicle. A number of patents and or publications have been made to address these issues. Exemplary examples of patents and or publication that try to address this/these problem(s) are identified and discussed below.

U.S. Pat. No. 4,493,491 issued Jan. 15, 1985 to Richard L. Karlik discloses an Apparatus for Transporting Truck Tractors and Truck Units. This patent is for a modified truck bed where the rear wheels of the vehicle being towed is pulled into the modified truck bed. While this patent allows a 5^{th} wheel vehicle to be towed, this does not operate with a standard 5^{th} wheel tow vehicle and does not include a boom on the vehicle that is being towed.

U.S. Pat. No. 4,149,643 issued on Apr. 17, 1979 to Kent D. Skala et al., discloses a Truck Tow Lift. The truck tow lift allows first 5^{th} truck to lift and tow a second 5^{th} wheel truck. This requires a separate boom to be secured between the two vehicles and the second 5^{th} wheel vehicle to be chained to the first 5^{th} wheel vehicle. While this patent allows for towing a 5^{th} wheel vehicle, it does not allow for towing a truck, it requires a vehicle to be chained and requires additional time to connect and disconnect the two vehicles together.

U.S. Pat. No. 2,481,223 issued Sep. 6, 1949 to B. M. Johnson discloses a Hoist and Tow Mechanism. The lifting mechanism is mounted onto the towing hitch of the 5^{th} wheel vehicle. The hoist is a chain that connects to the frame or bumper of the vehicle that is being towed. While this provides for a towing mechanism, the tow mechanism is mountable on the 5^{th} wheel vehicle and must be removed when the tow mechanism is not being used.

What is needed is a truck with a telescoping boom with a ball that fits into a receiver on a 5^{th} wheel truck. This allows a person to quickly hitch the truck that is being towed, the rear wheels lifted and one person can transport both vehicles. The proposed disclosure provides a solution with a telescoping boom that is secured to the bed of a truck.

### BRIEF SUMMARY OF THE INVENTION

It is an object of the telescoping boom for towing with a 5^{th} wheel for the telescoping boom to allow a single person to connect and transport two vehicles. The individual can drive the 5^{th} wheel to the truck, connect the truck with the 5^{th} wheel towing vehicle and drive both vehicles to transport both vehicles simultaneously to eliminate the need to transport two people to move the two vehicles.

It is an object of the telescoping boom for towing with a 5^{th} wheel for the truck to have a telescoping boom mounted within the bed of the truck. The boom has an adjustable length with hydraulics that can change the angle of the boom relative to the bed of the truck. The adjustable length allows the distance between the two vehicles to be adjustable. The distance allows the driver to tow the truck at a desired distance to accommodate geometry of the 5^{th} wheel and the truck being towed. While the geometry may be fairly standard, lighting, license plates and other structure can provide some variation that must be accommodated. In addition to an adjustable length for the boom, the boom angle is adjustable to alter the height of the boom above the ground that results on a difference of the height of the rear wheels above the ground.

It is another object of the telescoping boom for towing with a 5^{th} wheel to connect to a 5^{th} wheel transport vehicle. 5^{th} wheel transport vehicles are a standard used to tow heavy trailers or other vehicles. They provide a standard connection mechanism to tow heavy loads over city streets and highways.

It is still another object of the telescoping boom for towing with a 5^{th} wheel for the boom to be able to lift rear wheels of the truck that will be towed. The ability to lift the rear wheels allows the truck to be easily towed while the front wheels can freely turn to allow the truck to corner around turns. The rear wheels can be locked and the truck can still be towed.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a side view of a 5^{th} wheel vehicle connected to that truck that is being towed.

FIG. 2 shows a side view of a truck that can be towed with the boom retracted.

FIG. 3 shows a side view of the truck from FIG. 2 with the adjustments of the boom.

FIG. 4 shows a side view of the truck from FIGS. 2 and 3 with the boom connected to a 5^{th} wheel tow vehicle.

FIG. 5 shows a top plan view of the telescoping boom.

FIG. 6 shows a side view of the telescoping boom from FIG. 5.

### DETAILED DESCRIPTION OF THE INVENTION

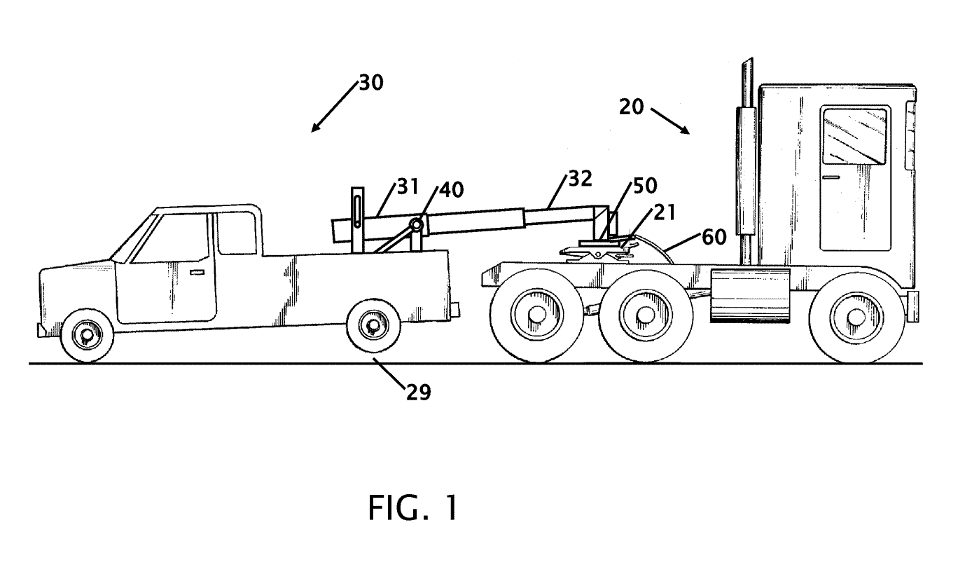

FIG. 1 shows a side view of a 5^{th} wheel vehicle 20 connected to that truck 30 that is being towed. This figure shows the truck 30 with the rear two wheels elevated 29 above the ground. With these two wheels elevated 29 above the ground where the truck 30 can be driven the truck 30 can be towed to another location with only a single driver within the 5^{th} wheel truck 20. The truck 30 has an adjustable boom mounted within the bed of the truck 30. From this figure the adjustable boom is extendable from a first beam 31 to at least a second beam 32. While this figure shows two beam elements 31 and 32 it is contemplated that more than one beam can be used to telescope to a further length from the bed of the truck 30. The beam elements 31 and 32 can be retracted within the bed of the truck 30 as shown and described in other figures of this disclosure.

The end of the last beam element 32 has a coupling 50 that connects to a coupling 21 in the 5^{th} wheel vehicle 20. The boom has a pivot 40 that allows the boom to pivot up and down to allow the boom to lift the rear wheels of the vehicle 30 being towed. When the boom is connected to the 5ht wheel 20 and electrical and or hydraulic connection 60 provides lighting commands and or control of the breaking, steering lighting and turn signal flashers of the vehicle being towed.

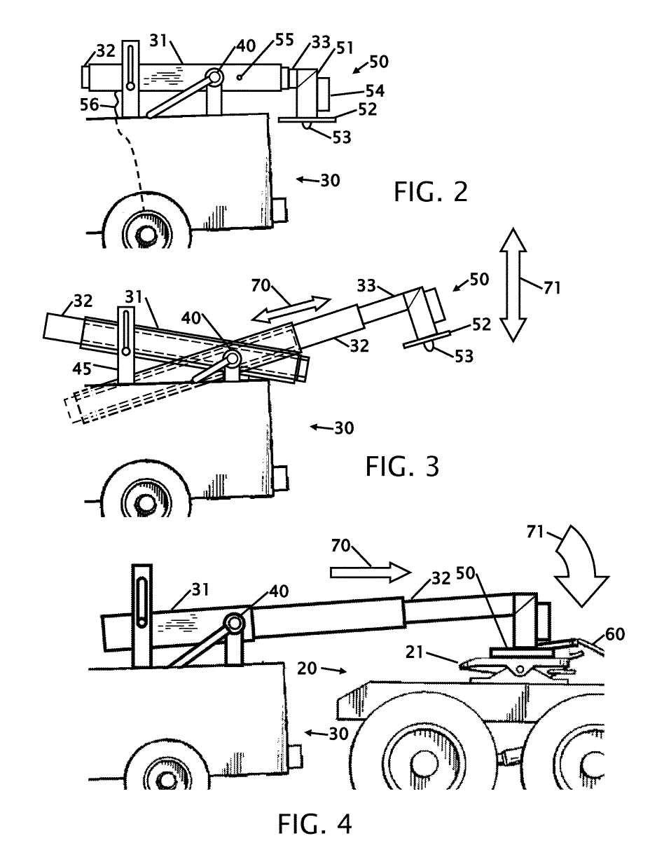

FIG. 2 shows a side view of a truck that can be towed with the boom retracted. This figure shows the three-section telescoping boom with the inner portion 32 of the telescoping boom retracted through the outer portion 31 or housing of the boom. This figure shows the boom being extendable over the tailgate of the truck, but could also be configured to fit within the bed of the truck 30. The telescoping part of the boom 32 is shown as a three elements 31, 32 and 33, but could be configured as more than three elements. Three sections allows the boom to be long enough to link to a 5^{th} wheel and also compact enough to fit within the bed of the pick-up truck. The pivot 40 is shown passing into the outer portion 31 of the boom. While this pivot is shown at the side nearest the tailgate, the pivot 40 can be located at the side nearest the cab of the truck.

Placing the pivot near the tailgate allows the height of the boom to be fairly fixed in relationship to the tailgate, and allows the end of the boom to be extended below the top lip of the tailgate. The connection mechanism 50 for connecting the boom to the 5^{th} wheel is located at the end of the boom. A vertical member of the boom on the connection mechanism 50 allows for angular movement between the boom and 5^{th} wheel. The mating plate 52 is shown, where the mating plate 52 can slide the mount with guide 53 into the hitch of a 5^{th} wheel. This is the retracted position. A handle 54 on the vertical portion 51 of the boom allows an operator to pull and push on the boom to change the length of the boom. A lock pin 55 fixes the length of the boom to prevent movement of the boom length. A cable 56 connects the boom through a hole in the bed of the pick-up truck to the differential of the pick-up truck to pull the boom into the frame of the pick-up truck.

FIG. 3 shows a side view of the truck 30 from FIG. 2 with the adjustments of the boom. The boom can be articulated to position the end of the slide mount 52 and the guide 53 into a receiver on a 5^{th} wheel. The end of the boom is elevated 71 to raise the mount 50 above the mounting height of the 5^{th} wheel. The angle of the telescoping boom is adjusted by a piston or actuator 45 that raises and lowers 71 the end of the boom. The boom pivots on the pivot link 40 that raises and lowers the end of the boom above and below the top lip of the tailgate.

Once the desired angle is achieved the boom is extended 70. In the embodiment shown the inner portion 32 of the boom is extended through the outer portion 31 of the boom. This figure further shows a third telescoping element 33 that extends from the inner boom element 33. The boom is extended until the mount 50 is sufficiently extended from the end of the truck 30 to a position that fits on a receiver on a 5th wheel. Once the mount 50 is positioned, the piston or actuator 45 lowers 71 the mount 50 onto the receiver on the 5th wheel. The piston 45 continues to extend until the wheels of the truck 30 are lifted above the ground as shown in FIG. 4.

FIG. 4 shows a side view of the truck 30 from FIGS. 2 and 3 with the boom connected to a 5^{th} wheel tow vehicle 20. Once the boom is lowered 71 the mount 50 and the receiver 21 are joined. By extending the piston at the end of the boom, the boom 31 will pivot on joint 40. Once the truck 30 and the 5^{th} wheel 20 are connected the distance between the truck 30 and the 5^{th} wheel 20 can be adjusted by adjusting 70 the extension on the telescoping boom 32. This figure shows a connection 60 into the end of the boom for electrical, pneumatic and or hydraulic communication from the 5^{th} wheel 20 to the truck 30. This connection 60 allows control of the lights and potentially the breaking of the truck to accommodate vehicle codes.

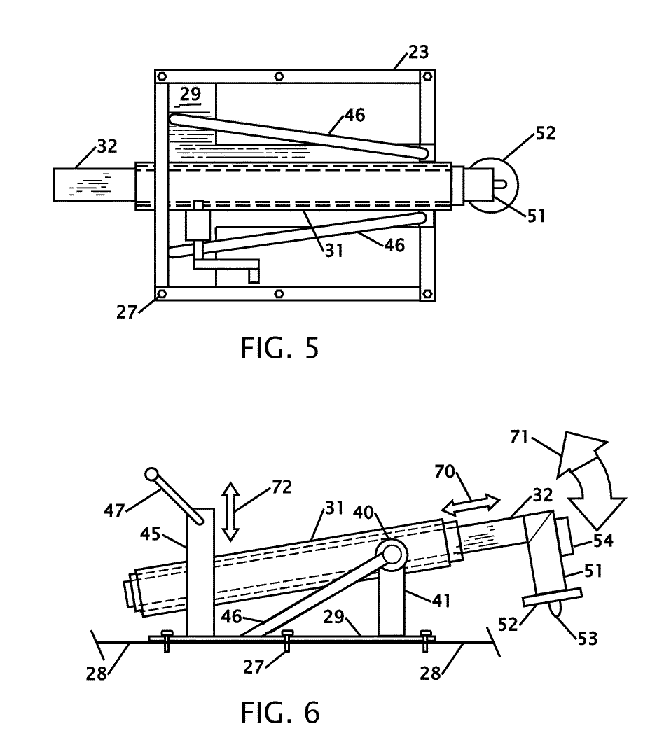

FIG. 5 shows a top plan view of the telescoping boom and FIG. 6 shows a side view of the telescoping boom from FIG. 5. The telescoping boom has a base 29 that is mounted to the bed 28 of the truck. These figures show the base 29 and base frame 23 bolted 27 or otherwise secured to the bed of the truck. Clearance 29 allows for the wheel wells of the truck to fit on the outsides of the base 23. It is contemplated that the base can be welded to the bed of the truck, or that the truck bed is fabricated with the telescoping boom integrated to the bed of the vehicle. From the side view of FIG. 6, the main housing of the boom 32 is shown with the pivot 40 secured to support 41 that secures the boom and allows the pivoting action by lifting or lowering 72 the lifting column 45. Tubes 46 anchor the joint 40 to the base 29.

At the other end of the boom, piston, cylinder, crank or actuator 47 is shown connected with a mount 45 that pivotally connects between the base mount 23 and the boom 31 through pivot 40. Extending or retracting 72 the actuator 45 will change the angle of the boom. While this figure shows the actuator 45 and the pivot 40 on particular sides of the boom, one skilled in the art could alter the locations between these two positions to provide equivalent lifting of the rear wheels of the vehicle for towing the truck. The rear wheels of the truck are raised by adjusting the extension 70 of the boom 32 and the angle 71 of the boom 32. Once the pad 52 and hitch 53 are secured within a receiver on the 5^{th} wheel the actuator 45 is adjusted to lift the rear wheels of the truck thereby allowing the truck to be towed by the driver of the 5^{th} wheel.

Thus, specific embodiments of a telescoping boom for towing with a 5^{th} wheel have been disclosed. It should be apparent, however, to those skilled in the art that many more modifications besides those described are possible without departing from the inventive concepts herein. The inventive subject matter, therefore, is not to be restricted except in the spirit of the appended claims.

1. A telescoping boom for towing with a 5^{th} wheel comprising:
a truck having a bed;
said truck having an adjustable boom mounted within said bed;
said adjustable boom having a first adjustment that extends said boom;
said adjustment further having a second adjustment that alters an angle of said boom wherein said angle alters a height of a first end of said boom above a ground surface where said truck rolls;
said first end further has a coupling for coupling said first end to a 5^{th} wheel vehicle, and
said second adjustment allows two wheels of said truck to be elevated.

2. The telescoping boom for towing with a 5^{th} wheel according to claim 1 wherein when said two wheels of said truck are elevated said truck is towable with said 5^{th} wheel vehicle;

3. The telescoping boom for towing with a 5^{th} wheel according to claim 2 wherein said elevating is by altering a position of said boom through a pivot point of said boom to alter said height of said first end of said boom.

4. The telescoping boom for towing with a 5^{th} wheel according to claim 2 wherein said altering of said boom is with a mechanical crank lift mechanism.

5. The telescoping boom for towing with a 5^{th} wheel according to claim 2 wherein said altering of said boom is with a hydraulic jack.

6. The telescoping boom for towing with a 5^{th} wheel according to claim 1 wherein said first adjustment extends said boom from within said bed to said 5^{th} wheel vehicle.

7. The telescoping boom for towing with a 5^{th} wheel according to claim 1 wherein said first adjustment extends said boom behind said bed to said 5^{th} wheel vehicle

8. The telescoping boom for towing with a 5^{th} wheel according to claim 1 wherein said coupling is pivotally secured to said boom.

9. The telescoping boom for towing with a 5^{th} wheel according to claim 8 wherein said coupling further includes a mounting plate.

10. The telescoping boom for towing with a 5th wheel according to claim 8 wherein said coupling further includes a guide.

11. The telescoping boom for towing with a 5^{th} wheel according to claim 1 wherein said telescoping boom is temporally mounted within said truck.

12. The telescoping boom for towing with a 5^{th} wheel according to claim 1 wherein said telescoping boom is welded into said truck.

13. The telescoping boom for towing with a 5^{th} wheel according to claim 1 further includes a cable connecting said adjustable boom to a differential of said truck.

14. The telescoping boom for towing with a 5^{th} wheel according to claim 13 wherein said cable passes through a hole in said bed of said truck.

15. The telescoping boom for towing with a 5^{th} wheel according to claim 1 further includes at least one locking pin in said boom to fix a length of extension of said boom.

16. The telescoping boom for towing with a 5^{th} wheel according to claim 1 wherein said boom extends over a tailgate of said truck.

17. The telescoping boom for towing with a 5^{th} wheel according to claim 1 wherein said boom includes at least three sections.

18. The telescoping boom for towing with a 5^{th} wheel according to claim 1 wherein said length of said boom is manually extended and retracted.

19. The telescoping boom for towing with a 5^{th} wheel according to claim 1 wherein said length of said boom is hydraulically extended and retracted.

20. The telescoping boom for towing with a 5^{th} wheel according to claim 1 further includes an electrical connection to lighting from said truck to said 5^{th} wheel.
